(19) United States
(12) Patent Application Publication
(10) Pub. No.: US 2009/0115163 A1
(43) Pub. Date: May 7, 2009

(54) TRAILER

(76) Inventors: David C. Winter, Layton, UT (US); Kevin Boydston, Clinton, UT (US); Mitch Johnson, South Weber, UT (US)

Correspondence Address: Workman Nydegger;1000 Eagle Gate Tower, 60 East South Temple, Salt Lake City, UT, 84111, US

(21) Appl. No.: 12/263,049

(22) Filed: Oct. 31, 2008

Related U.S. Application Data
(60) Provisional application No. 60/985,062, filed on Nov. 2, 2007.
(60) Provisional application No. 60/985,117, filed on Nov. 2, 2007.
(60) Provisional application No. 60/990,243, filed on Nov. 26, 2007.

(51) Int. Cl. B62D 63/06

(52) U.S. Cl. 280/418.1

(57) ABSTRACT

A trailer may include a connection assembly. The connection assembly may include an arm sized and configured to be connected to a vehicle to allow the vehicle to tow the trailer. The towing arm may be movable between extended and retracted positions. The trailer may also include a handle assembly, which may be movable between extended and retracted positions relative to the towing arm. The trailer may be easily towed by the vehicle when, for example, the towing arm is extended and the handle assembly is retracted. The trailer may also be used as a wheelbarrow when, for example, the towing arm is retracted and the handle assembly is extended. The connection assembly, the handle assembly, and/or other components of the trailer may include openings that may be aligned to receive fasteners to secure the towing arm and/or the handle assembly in the extended and/or retracted positions.

### CROSS-REFERENCE TO RELATED APPLICATIONS

This application claims priority to, and the benefit of, U.S. provisional patent application Ser. No. 60/985,062, filed Nov. 2, 2007 and entitled TRAILER.

This application claims priority to, and the benefit of, U.S. provisional patent application Ser. No. 60/985,117, filed Nov. 2, 2007 and entitled TRAILER.

This application claims priority to, and the benefit of, U.S. provisional patent application Ser. No. 60/990,243, filed Nov. 26, 2007 and entitled TRAILER.

The disclosures of each of these applications are incorporated by reference in their entireties.

### BACKGROUND OF THE INVENTION

1. Field of the Invention

The present invention generally relates to storage and/or transportation systems and, in particular, to trailers.

2. Description of Related Art

Conventional trailers are unpowered vehicles that may be pulled by a powered vehicle. Trailers are commonly used to transport various goods and materials. Trailers may be for personal use and may be used with powered vehicles with an appropriate hitch.

A common type of trailer is a utility trailer that may be used to haul a variety of different types of materials. Disadvantageously, some trailers may be difficult to use and/or awkward to store. In addition, some trailers may have relatively limited uses.

Another type of conventional device use to transport goods and materials is a wheelbarrow. Known wheelbarrows are small hand-propelled vehicles, usually with just one wheel, which are designed to be pushed and guided by a single person using two handles disposed towards the rear of the wheelbarrow.

Wheelbarrows are frequently designed to distribute the weight of its load between the wheel and the operator, which may allow heavier and bulkier loads to be moved. Wheelbarrows are commonly in the construction industry and in gardening. A conventional wheelbarrow typically has a capacity of approximately six cubic feet of material.

It is also known to construct wheelbarrows with two wheels, which may make the wheelbarrow more stable on level ground. The two wheels, however, may make the wheelbarrow more difficult to use in certain circumstances. The two wheels may also make the wheelbarrow more difficult to load and unload, especially if the contents are being dumped out of the wheelbarrow.

### BRIEF SUMMARY OF EMBODIMENTS OF THE INVENTION

A need therefore exists for a trailer that eliminates or diminishes the disadvantages and problems described above.

One aspect is a trailer that may include a connection assembly which is sized and configured to be connected to a vehicle to allow the vehicle to tow the trailer. For example, the connection assembly may include an arm or tongue that is sized and configured to be connected to the vehicle.

Another aspect is a trailer that may include a connection assembly which may be moved between an extended position and a retracted position. Desirably, when in the extended position, the connection assembly may be readily connected to a towing vehicle, and when in the retracted position, the connection assembly may be more compact, thus facilitating more efficient storage of the trailer. When the connection assembly is in the retracted position, a portion of the connection assembly, such as a foot, may be positioned to contact, abut and/or engage a support surface, such as the ground, which may advantageously help stabilize the trailer. Significantly, with a portion of the connection assembly contacting, abutting and/or engaging the support surface, the trailer may be used for other purposes. In particular, the trailer may include a handle, which may allow the trailer to be used as a wheelbarrow in such instances.

A further aspect is a trailer that may include a connection assembly with a first member and a second member. The first member may be connected to an axle, a container and/or other portions of the trailer. The second member may be sized and configured to be connected to a vehicle to allow the vehicle to tow the trailer. Desirably, the first and second members may be movably interconnected to allow the second member and/or the connection assembly to move between an extended position and a retracted position. A foot may be connected to, or form part of, the second member and may contact, abut and/or engage a support surface when the second member and/or the connection assembly are in the retracted position.

Another further aspect is a trailer that may include a connection assembly which is sized and configured to be selectively locked in the extended position and/or in the retracted position. For example, the connection assembly may include a first member, a second member and a foot. To lock the connection assembly in the extended position, a fastener (such as a locking pin) may be inserted through openings formed in the first and second members to secure them in a generally fixed relative position. Also, to lock the connection assembly in the extended position, a fastener may be inserted through openings formed in the first member and the foot to secure them in a generally fixed relative position. In addition, to lock the connection assembly in the retracted position, a fastener may be inserted through openings formed in the second member and a retaining member to secure them in a generally fixed relative position. The retaining member may be connected to, for example, a container and/or other portions of the trailer.

Yet another further aspect is a trailer that may include a connection assembly and a handle assembly. The connection assembly may include a towing arm that may be sized and configured to move between extended and retracted positions. The handle assembly may be movably connected to the towing arm, which may help the handle assembly move between extended and retracted positions relative to the towing arm. Significantly, when the towing arm is extended and the handle assembly is retracted, the trailer may be easily towed by vehicle. In addition, when the towing arm is retracted and the handle assembly is extended, the trailer may be used as a wheelbarrow.

A further aspect is a trailer that may include a connection assembly, handle assembly, and/or other components with openings that may be aligned to receive fasteners to secure the towing arm and/or the handle assembly in the extended and/or retracted positions. For example, the connection assembly may include a first set of openings and a second set of openings, and the handle assembly may include a set of openings that may be aligned with the connection assembly's first set of openings when the handle assembly is retracted and aligned with the connection assembly's second set of openings when the handle assembly is extended. The trailer may also include a retaining member with a set of openings that may be aligned with the connection assembly's first set of openings when the handle assembly is extended and the towing arm is retracted. In addition, the connection assembly may include first and second members with openings that may be aligned when the towing arm is extended and the handle assembly is retracted.

Still another aspect is a trailer that may include a container which is sized and configured to be moved among a plurality of positions. For example, the container may be moved from a carrying position in which contents remain in the container and a dumping position in which the contents are dumped out of the container. The container may be sized and configured to be selectively locked in the carrying position. For example, the trailer may include a locking mechanism. The locking mechanism may include a first bracket that may be connected to the container, a second bracket that may be connected to a connection assembly, and a latch that may move between a locked position and an unlocked position. When the latch is in the locked position, the latch may engage a portion of the first and second brackets to lock the container in the carrying position. When the latch is in the unlocked position, the latch may disengage the first and second brackets to allow the container to be freely moved between the carrying position and the dumping position. If desired, the latch may be biased towards the locked position and/or away from the unlocked position using a spring and/or other biasing members. Significantly, this may allow the locking mechanism to automatically lock when the container is moved to the carrying position. If desired, the latch may be positioned above and/or apart from the connection assembly, which may help provide a simpler and/or stronger design for the connection assembly.

Another aspect is a trailer that may include a container. For example, the trailer may include a tub or other type of container. The container may be constructed from molded plastic and may include one or more features integrally formed in the container during the molding process. For instance, the container may include one or more cup holders or trays integrally formed in the container during the molding process. The container may also include one or more handles integrally formed in the container during the molding process. The handles may, for example, be disposed in an under portion a lip of the container, may extend outwardly away from the body of the container and/or may have other suitable configurations and positions. In addition, the container may include one or more tool holders integrally formed in the container during the molding process. The tool holders may include receiving portions sized and configured to receive and/or retain at least a portion of one or more tools, such as rakes, brooms, shovels, hammers and/or other tools. The receiving portions may be sized and configured to receive and/or retain at least a portion of one or more tools using a snap, friction and/or interference fit. In some instances, the receiving portions may include recesses, passageways and/or openings into which portions of the tools may be inserted to help retain the tool and/or allow the tools to hang from the receiving portions. The container may be constructed using a blow molding process, an injection molding process and/or any other molding process.

These and other aspects, features and advantages of the present invention will become more fully apparent from the following detailed description of preferred embodiments and appended claims.

### BRIEF DESCRIPTION OF THE DRAWINGS

The appended drawings contain figures of preferred embodiments to further illustrate and clarify the above and other aspects, advantages and features of the present invention. It will be appreciated that these drawings depict only preferred embodiments of the invention and are not intended to limit its scope. The invention will be described and explained with additional specificity and detail through the use of the accompanying drawings in which:

FIG. 1 is a perspective view of an exemplary trailer, illustrating a towing arm in an extended position and a handle assembly in a retracted position;

FIG. 2 is another perspective view of the trailer shown in FIG. 1, illustrating the towing arm in the extended position and the handle assembly in an extended position;

FIG. 3 is still another perspective view of the trailer shown in FIG. 1, illustrating the towing arm in a retracted position and the handle assembly in the extended position; and

FIG. 4 is still yet another perspective view of a portion of the trailer shown in FIG. 1, illustrating an exemplary container.

### DETAILED DESCRIPTION OF THE PREFERRED EMBODIMENTS

The present invention is generally directed towards a trailer. The principles of the present invention, however, are not limited to trailers. It will be understood that, in light of the present disclosure, the trailer disclosed herein can be successfully used in connection with other types of storage and/or transportation systems.

Additionally, to assist in the description of the trailer, words such as top, bottom, front, rear, right and left may be used to describe the accompanying figures, which are not necessarily drawn to scale. It will be appreciated, however, that the trailer can be located in a variety of desired positions and/or orientations.

Further, while the following detailed description and accompanying figures are discussed in connection with an exemplary trailer, it will be understood that the trailer may have a wide variety of shapes, sizes, configurations and arrangements. For example, the trailer may be used as a garden cart and may be used to transport gardening materials and supplies. The trailer may also be used as a utility trailer to transport various items, especially larger and bulky items. In addition, the trailer may be used in connection with the construction of various objects and articles. Thus, it will be appreciated that the invention is not limited to trailers and it may encompass a wide variety of different types of vehicles, carts, wheelbarrows, etc. A detailed description of the trailer now follows.

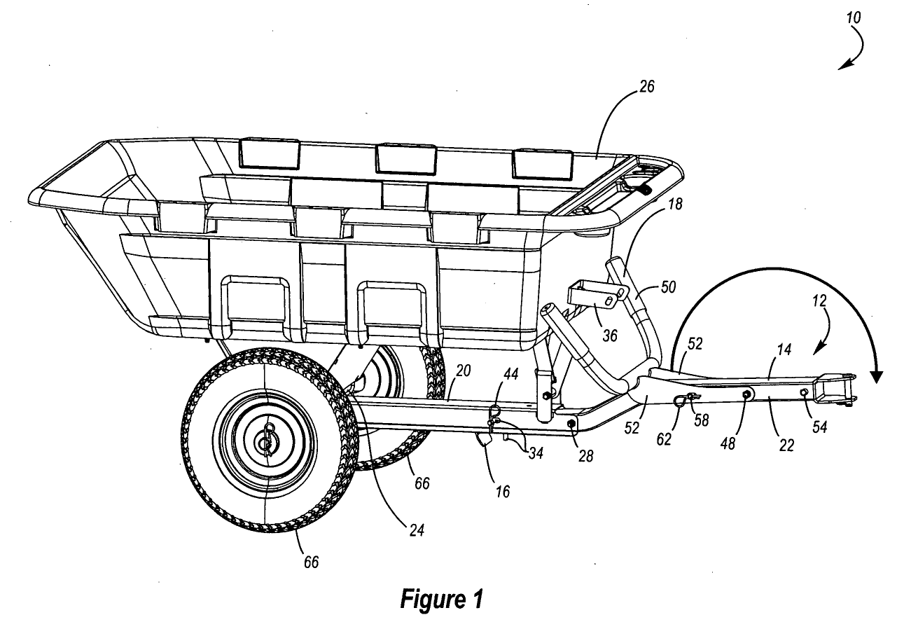

As shown in FIG. 1, a trailer 10 may include a connection assembly 12 that may be sized and configured to be connected to a vehicle to allow the vehicle to tow the trailer. For example, the connection assembly 12 may include an arm or tongue 14 that is sized and configured to be connected to the vehicle. The connection assembly 12 may be sized and configured to be connected to motorized vehicles, such as all-terrain vehicles (ATVs) and lawn tractors. Of course, the connection assembly 12 may be sized and configured to be connected to other types of vehicles, if desired.

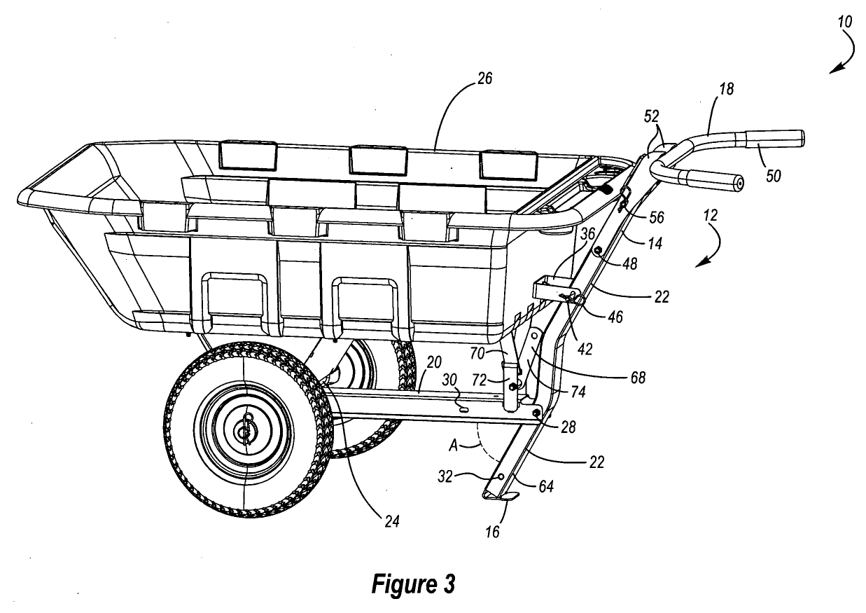

As shown in FIGS. 1-3, the connection assembly 12 may be moved an extended position and a retracted position. Desirably, when in the extended position shown in FIG. 1, the connection assembly 12 may be readily connected to a towing vehicle, and when in the retracted position shown in FIG. 3, the connection assembly may be more compact, thus facilitating more efficient storage of the trailer 10.

Desirably, when the connection assembly 12 is in the retracted position, a portion of the connection assembly, such as a foot 16, may be positioned to contact, abut and/or engage a support surface, such as the ground, which may advantageously help stabilize the trailer 10. Significantly, with a portion of the connection assembly 12 contacting, abutting and/or engaging the support surface, the trailer 10 may be used for other purposes. In particular, the trailer may include a handle assembly 18, which may allow the trailer 10 to be used a wheelbarrow in such instances.

In further detail, the connection assembly 12 may include a first member 20 and a second member 22. The first member 20 may be connected to an axle 24, a container 26 and/or other portions of the trailer 10. The second member 22 may include the towing arm 14 and the foot 16.

The first and second members 20, 22 may be movably interconnected to allow the towing arm 14 and the foot 16 to move between extended and retracted positions. For example, the first and second members 20, 22 may be pivotally interconnected using a fastener 28, which may allow the towing arm 14 to pivot between the extended and retracted positions. As shown in FIG. 3, with the towing arm 14 in the retracted position, the foot 16 is preferably positioned to contact, abut and/or engage a support surface to help stabilize the trailer 10. As shown in FIG. 1, with the towing arm 14 in the extended position, the foot 16 is preferably spaced apart from the support surface to allow the trailer 10 to be more easily towed. The towing arm 14, the first member 20, the second member 22 and the foot 16 may have a variety of sizes, shapes and/or configurations depending, for example, upon the particular configuration of the connection assembly 12. It will be appreciated that the connection assembly 12 may include other components have other suitable features, if desired.

The towing arm 14 and the foot 16 may be sized and configured to be selectively locked in the extended and/or retracted positions. For example, the first and second members 20, 22 and/or other components of the trailer 10 may include openings sized and configured to receive fasteners to selectively lock the towing arm 14 and the foot 16 in the extended and/or retracted positions.

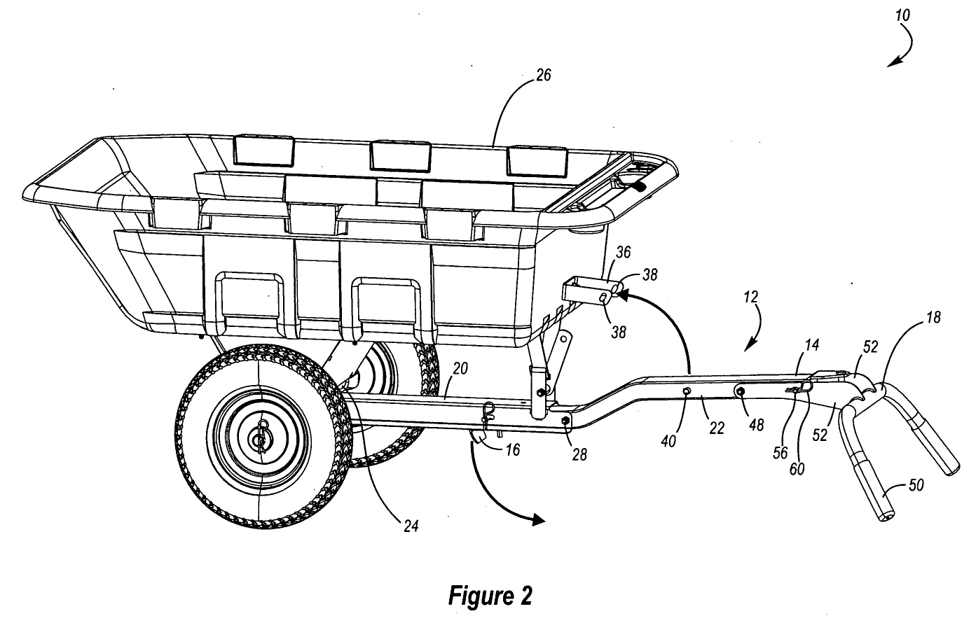

In further detail, the first and second members 20, 22 may include openings 30, 32 shown in FIG. 3. As shown in FIG. 1, the openings 30, 32 may be aligned and receive a fastener 34 when the towing arm 14 is extended and the foot 16 is retracted. In addition, as shown in FIG. 2, the trailer 10 may include a retaining member 36 connected to the container 26, and the bracket and the member 22 may include openings 38, 40. As shown in FIG. 3, the openings 38, 40 may be aligned and receive a fastener 42 when the towing arm 14 is retracted and the foot 16 is extended. As shown in FIGS. 1 and 3, cotter pins 44, 46 may be used to retain the fasteners 34, 42 within the openings 30, 32, 38, 40, but this is not required depending, for example, upon the particular configuration of the fasteners.

As shown in FIGS. 1 and 2, the connection assembly 12 and the handle assembly 18 may be movably interconnected to allow the handle assembly 18 to move between extended and retracted positions. For example, the connection assembly 12 and the handle assembly 18 may be movably interconnected using a fastener 48. In greater detail, the handle assembly 18 may include a handle 50 and one or more brackets 52 connected to the handle. The brackets 52 may be pivotally connected to the second member 22 of the connection assembly 12 using the fastener 48, which may allow the handle assembly 18 to move between the extended and retracted positions.

The handle assembly 18 may be sized and configured to be selectively locked in the extended and/or retracted positions. For example, connection assembly 12 and the handle assembly 18 may include openings sized and configured to receive fasteners to selectively lock handle assembly 18 in the extended and/or retracted positions. In greater detail, the second member 22 of the connection assembly 12 may include one or more openings 54 shown in FIG. 2. The brackets 52 may include one or more openings that may be aligned with the openings 54, and as shown in FIG. 2, the aligned openings may receive a fastener 56 when the handle assembly 18 is in the extended position. The openings of the brackets 52 may also be aligned with the openings 40 to receive a fastener 58 when the handle assembly 18 is in the retracted position shown in FIG. 1. As shown in FIGS. 1-2, cotter pins 60, 62 may be used to retain the fasteners 56, 58 within the openings in the brackets 52 and the openings 40, 54, but this is not required depending, for example, upon the particular configuration of the fasteners.

As shown in FIG. 3, a first end of the member 22 may include the towing arm 14 and a second end of the member may include the foot 16. The second end of the member 22 may, in particular, include a leg 64 that may be connected to and/or include the foot 16. The leg 64 may be sized and configured to move from a first position in which the first member 20 and the leg are generally aligned and a second position in which the first member and the leg are at an angle. For example, when in the second position, the first member 20 and the leg 64 may be disposed at an angle A that is about sixty degrees, about ninety degrees or other suitable angles.

Thus, as shown above, the connection assembly 12 may include a first set of openings 40 and a second set of openings 54, and the handle assembly 18 may include a set of openings that may be aligned with the first set of openings when the handle assembly is retracted and aligned with the second set of openings when the handle assembly is extended. In addition, the retaining member 36 may include a set of openings 38 that may be aligned with the first set of openings 40 when the towing arm 14 is retracted and the foot 16 and handle assembly 18 are extended. In addition, the first and second members 20, 22 of the connection assembly 12 may include openings 30, 32 that may be aligned when the towing arm 14 is extended and the foot 16 and handle assembly 18 are retracted.

Significantly, as discussed above, these aligned openings may receive fasteners (such as the fasteners 34, 42, 56, 58) to selectively secure the towing arm 14, the foot 16 and/or the handle assembly 18 in extended and/or retracted positions. In some embodiments, fasteners may be sized and configured to be interchangeably inserted into and received by these aligned openings. Accordingly, four fasteners 34, 42, 56, 58 are not required and merely two fasteners could be interchangeably received by the aligned openings. It will be appreciated, however, that the aligned openings and fasteners are not required and that the towing arm 14, the foot 16 and/or the handle assembly 18 may be selectively locked in extended and retracted positions using any other suitable means.

Accordingly, as shown in FIG. 1 where the towing arm 14 is secured in the extended position and the foot 16 and handle assembly 18 are secured in retracted position, the towing arm 14 may be connected to a vehicle to allow the vehicle to tow the trailer 10. As shown in FIG. 1, the trailer 10 may include one or more wheels 66 to facilitate such towing. In addition, as shown in FIG. 3 where the towing arm 14 is secured in the retracted position and the foot 16 and handle assembly 18 are secured in extended position, the handle 50 may be used to lift raise the foot 66 of a support surface, allowing the trailer 10 be used as a wheelbarrow.

In some embodiments, the container 26 may be sized and configured to be moved among a plurality of positions. For example, the container 26 may be moved from a carrying position in which contents remain in the container and a dumping position in which the contents are dumped out of the container. The container may be sized and configured to be selectively locked in the carrying position. For example, as shown in FIG. 3, the trailer 10 may include a locking mechanism 68. The locking mechanism 68 may include a first bracket 70 that may be connected to the container 20, a second bracket 72 that may be connected to the connection assembly 12, and a latch 74 that may move between a locked position and an unlocked position. The latch 74 may be movably (for instance, pivotally) connected to the first bracket 70 or the second bracket 72 to help the latch move between the locked and unlocked positions.

When the latch 74 is in the locked position, the latch may engage a portion of the brackets 70, 72 to lock the container in the carrying position. For example, the latch 74 may comprise a link and, to lock the container in the carrying position, the link may include a receiving portion (such as a notch) that may be sized and configured receive, retain and/or engage a portion of the bracket 70 and a portion of the bracket 72. When the latch 74 is in the unlocked position, the latch may disengage the brackets 70, 72 to allow the container to be freely moved between the carrying position and the dumping position. If desired, the latch 74 may be biased towards the locked position and/or away from the unlocked position using a spring and/or other types of biasing members. Significantly, this may allow the locking mechanism 68 to automatically lock when the container 26 is moved to the carrying position. If desired, the latch 74 may be positioned above and/or apart from the connection assembly 12, which may help provide a simpler and/or stronger design for the connection assembly. It will be appreciated, however, that the latch 74 may be positioned in other suitable locations and need not be biased. It will also be appreciated that the locking mechanism 68 need not be automatic and may include a variety of other components, if desired.

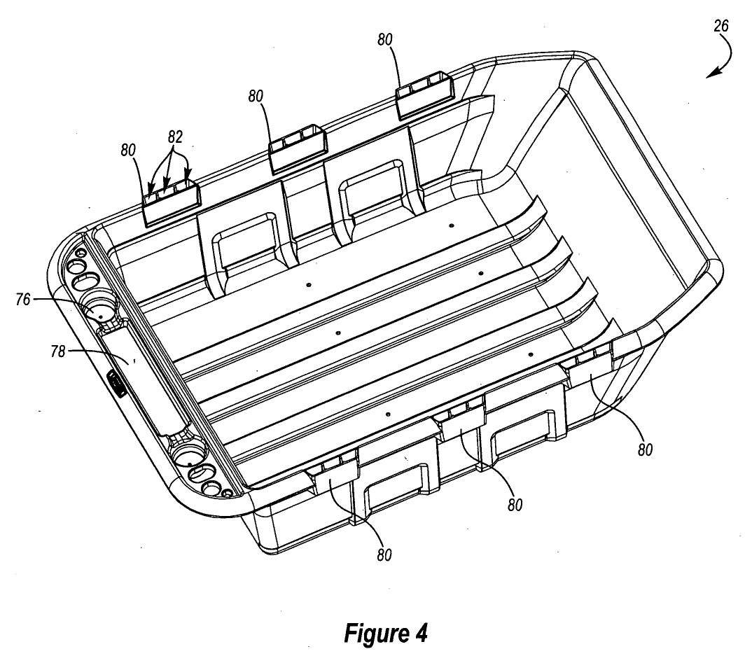

As shown in FIG. 4, the container 26 (such as a tub or other type of container) may be constructed from molded plastic and may include one or more features integrally formed in the container during the molding process. For instance, the container 26 may include one or more cup holders 76 or trays 78 integrally formed in the container during the molding process. The container may 26 also include one or more tool holders 80 integrally formed in the container during the molding process. The tool holders 80 may include receiving portions 82 sized and configured to receive and/or retain at least a portion of one or more tools, such as rakes, brooms, shovels, hammers and/or other tools. The receiving portions 82 may be sized and configured to receive and/or retain at least a portion of one or more tools using a snap fit, a friction fit and/or an interference fit. In some instances, the receiving portions may include recesses, passageways and/or openings into and/or through which portions of the tools may be inserted to help retain the tool and/or allow the tools to hang from the receiving portions. In addition, the container 26 may include one or more handles integrally formed in the container during the molding process. The handles may, for example, be disposed in an under portion a lip of the container, may extend outwardly away from the body of the container and/or may have other suitable configurations and positions. The container 26 may be constructed using a blow molding process, an injection molding process and/or any other molding process. It will be appreciated, however, that the container need not be constructed using plastic or a molding process and that other suitable materials and/or processes may be used to construct the container.

Other suitable features for trailers are disclosed in U.S. provisional patent application Ser. No. 60/985,062, filed Nov. 2, 2007; U.S. provisional patent application Ser. No. 60/985,117, filed Nov. 2, 2007; and U.S. provisional patent application Ser. No. 60/990,243, filed Nov. 26, 2007—which are incorporated by reference above.

Although this invention has been described in terms of certain preferred embodiments, other embodiments apparent to those of ordinary skill in the art are also within the scope of this invention. Accordingly, the scope of the invention is intended to be defined only by the claims which follow.

What is claimed is:

1. A trailer comprising:
a container;
one or more wheels;
a connecting assembly including:
a first member; and
a second member pivotally connected to the first member, the second member including a towing arm and a foot, the second member being sized and configured to pivot between a first position in which the towing arm is extended and the foot is retracted and a second position in which the towing arm is retracted and the foot is extended; and
a handle assembly pivotally connected to the second member, the handle assembly being sized and configured to pivot between an extended position and a retracted position relative to the second member, the handle assembly comprising:
a bracket pivotally connected to the second member of the connecting assembly; and
a handle connected to the bracket of the handle assembly.

2. The trailer as in claim 1, further comprising:
a retaining member;
an opening formed in the retaining member;
an opening formed in the bracket of the handle assembly;
an opening formed in the first member of the connecting assembly;
a first opening formed in the second member of the connecting assembly;
a second opening formed in the second member of the connecting assembly;
a third opening formed in the second member of the connecting assembly;
wherein the opening formed in the bracket is sized and configured to, when the handle assembly is in the retracted position and the second member of the connecting assembly is in the first position in which the towing arm is extended and the foot is retracted, be aligned with the first opening formed in the second member to receive a fastener that secures the handle assembly in the retracted position;
wherein the opening formed in the bracket is sized and configured to, when the handle assembly is in the extended position and the second member of the connecting assembly is in the second position in which the towing arm is retracted and the foot is extended, be aligned with the second opening formed in the second member to receive a fastener that secures the handle assembly in the extended position;
wherein the opening formed in the retaining member is sized and configured to, when the handle assembly is in the extended position and the second member of the connecting assembly is in the second position in which the towing arm is retracted and the foot is extended, be aligned with the first opening formed in the second member to receive a fastener that secures the connecting assembly in the second position; and
wherein the opening formed in the first member of the connecting assembly is sized and configured to, when the second member of the connecting assembly is in the first position in which the towing arm is extended and the foot is retracted, be aligned with the third opening formed in the second member of the connecting assembly to receive a fastener that secures the connecting assembly in the first position.

3. The trailer as in claim 1, further comprising:
a retaining member;
an opening formed in the retaining member;
an opening formed in the bracket of the handle assembly;
a first opening formed in the second member of the connecting assembly;
a second opening formed in the second member of the connecting assembly;
wherein the opening formed in the bracket is sized and configured to, when the handle assembly is in the retracted position and the second member of the connecting assembly is in the first position in which the towing arm is extended and the foot is retracted, be aligned with the first opening formed in the second member to receive a fastener that secures the handle assembly in the retracted position;
wherein the opening formed in the bracket is sized and configured to, when the handle assembly is in the extended position and the second member of the connecting assembly is in the second position in which the towing arm is retracted and the foot is extended, be aligned with the second opening formed in the second member to receive a fastener that secures the handle assembly in the extended position; and
wherein the opening formed in the retaining member is sized and configured to, when the handle assembly is in the extended position and the second member of the connecting assembly is in the second position in which the towing arm is retracted and the foot is extended, be aligned with the first opening formed in the second member to receive a fastener that secures the connecting assembly in the second position.

4. The trailer as in claim 1, further comprising a locking mechanism including:
a first bracket connected to the container;
a second bracket connected to the first member of the connecting assembly; and
a latch movable between a locked position and an unlocked position, the latch including a notch;
wherein the container is sized and configured to move between a carrying position and a dumping position;
wherein the notch of the latch is sized and configured to, when the latch is in the locked position and the container is in the carrying position, engage the first and second brackets of the locking mechanism to lock the container in the carrying position; and
wherein the notch of the latch is sized and configured to, when the latch is in the unlocked position, be disengaged from the first and second brackets of the locking mechanism to allow the container to be freely moved between the carrying and dumping positions.

5. The trailer as in claim 4, wherein the latch comprises a link that includes the notch.

6. The trailer as in claim 4, wherein the latch is positioned above and apart from the first member of the connecting assembly.

7. A trailer comprising:
a container;
one or more wheels;
a connecting assembly including:
a first member; and
a second member movably connected to the first member, the second member including a towing arm and a foot, the second member being sized and configured to move between a first position in which the towing arm is extended and the foot is retracted and a second position in which the towing arm is retracted and the foot is extended; and
a handle assembly movably connected to the second member, the handle assembly being sized and configured to move between an extended position and a retracted position relative to the second member.

8. The trailer as in claim 6, further comprising:
a retaining member;
an opening formed in the retaining member;
an opening formed in the handle assembly;
an opening formed in the first member of the connecting assembly;
a first opening formed in the second member of the connecting assembly;
a second opening formed in the second member of the connecting assembly;
a third opening formed in the second member of the connecting assembly;
wherein the opening formed in the handle assembly is sized and configured to, when the handle assembly is in the retracted position and the second member of the connecting assembly is in the first position in which the towing arm is extended and the foot is retracted, be aligned with the first opening formed in the second member to receive a fastener that secures the handle assembly in the retracted position;
wherein the opening formed in the handle assembly is sized and configured to, when the handle assembly is in the extended position and the second member of the connecting assembly is in the second position in which the towing arm is retracted and the foot is extended, be aligned with the second opening formed in the second member to receive a fastener that secures the handle assembly in the extended position;
wherein the opening formed in the retaining member is sized and configured to, when the handle assembly is in the extended position and the second member of the connecting assembly is in the second position in which the towing arm is retracted and the foot is extended, be aligned with the first opening formed in the second member to receive a fastener that secures the connecting assembly in the second position; and
wherein the opening formed in the first member of the connecting assembly is sized and configured to, when the second member of the connecting assembly is in the first position in which the towing arm is extended and the foot is retracted, be aligned with the third opening formed in the second member of the connecting assembly to receive a fastener that secures the connecting assembly in the first position.

9. The trailer as in claim 6, further comprising:
a retaining member;
an opening formed in the retaining member;
an opening formed in the handle assembly;
a first opening formed in the second member of the connecting assembly;
a second opening formed in the second member of the connecting assembly;
wherein the opening formed in the handle assembly is sized and configured to, when the handle assembly is in the retracted position and the second member of the connecting assembly is in the first position in which the towing arm is extended and the foot is retracted, be aligned with the first opening formed in the second member to receive a fastener that secures the handle assembly in the retracted position;
wherein the opening formed in the handle assembly is sized and configured to, when the handle assembly is in the extended position and the second member of the connecting assembly is in the second position in which the towing arm is retracted and the foot is extended, be aligned with the second opening formed in the second member to receive a fastener that secures the handle assembly in the extended position; and
wherein the opening formed in the retaining member is sized and configured to, when the handle assembly is in the extended position and the second member of the connecting assembly is in the second position in which the towing arm is retracted and the foot is extended, be aligned with the first opening formed in the second member to receive a fastener that secures the connecting assembly in the second position.

10. The trailer as in claim 6, further comprising a locking mechanism including:
a first bracket connected to the container;
a second bracket connected to the first member of the connecting assembly; and
a latch movable between a locked position and an unlocked position, the latch including a receiving portion;
wherein the container is sized and configured to move between a carrying position and a dumping position;
wherein the receiving portion of the latch is sized and configured to, when the latch is in the locked position and the container is in the carrying position, engage the first and second brackets of the locking mechanism to lock the container in the carrying position; and
wherein the receiving portion of the latch is sized and configured to, when the latch is in the unlocked position, be disengaged from the first and second brackets of the locking mechanism to allow the container to be freely moved between the carrying and dumping positions.

11. The trailer as in claim 10, wherein the latch comprises a link that includes the receiving portion.

12. The trailer as in claim 10, wherein the latch is positioned above and apart from the first member of the connecting assembly.

13. A trailer comprising:
a container sized and configured to move between a carrying position and a dumping position;
one or more wheels;
a connecting assembly sized and configured to be connected to a towing vehicle;
a handle assembly; and
a locking mechanism including:
a first bracket connected to the container;
a second bracket connected to the connecting assembly; and
a latch movable between a locked position and an unlocked position, the latch including a receiving portion;
the receiving portion of the latch being sized and configured to, when the latch is in the locked position and the container is in the carrying position, engage the first and second brackets of the locking mechanism to lock the container in the carrying position; and
the receiving portion of the latch being sized and configured to, when the latch is in the unlocked position, be disengaged from the first and second brackets of the locking mechanism to allow the container to be freely moved between the carrying and dumping positions.

14. The trailer as in claim 13, wherein the latch comprises a link that includes the receiving portion.

15. The trailer as in claim 13, wherein the receiving portion comprises a notch.

16. The trailer as in claim 13, wherein the latch is positioned above and apart from the connecting assembly.

17. The trailer as in claim 13, wherein the handle assembly is movably connected to the connecting assembly, the handle assembly being sized and configured to move between an extended position and a retracted position relative to the connecting assembly.

18. The trailer as in claim 13, further comprising:
a retaining member;
an opening formed in the retaining member;
an opening formed in the handle assembly;
an opening formed in the first member of the connecting assembly;
a first opening formed in the second member of the connecting assembly;
a second opening formed in the second member of the connecting assembly;
a third opening formed in the second member of the connecting assembly;
wherein the connecting assembly includes a first member and a second member movably connected to the first member, the second member including a towing arm and a foot, the second member being sized and configured to move between a first position in which the towing arm is extended and the foot is retracted and a second position in which the towing arm is retracted and the foot is extended;
wherein the handle assembly is movably connected to the connecting assembly, the handle assembly being sized and configured to move between an extended position and a retracted position relative to the connecting assembly;
wherein the opening formed in the handle assembly is sized and configured to, when the handle assembly is in the retracted position and the second member of the connecting assembly is in the first position in which the towing arm is extended and the foot is retracted, be aligned with the first opening formed in the second member to receive a fastener that secures the handle assembly in the retracted position;
wherein the opening formed in the handle assembly is sized and configured to, when the handle assembly is in the extended position and the second member of the connecting assembly is in the second position in which the towing arm is retracted and the foot is extended, be aligned with the second opening formed in the second member to receive a fastener that secures the handle assembly in the extended position;
wherein the opening formed in the retaining member is sized and configured to, when the handle assembly is in the extended position and the second member of the connecting assembly is in the second position in which the towing arm is retracted and the foot is extended, be aligned with the first opening formed in the second member to receive a fastener that secures the connecting assembly in the second position; and
wherein the opening formed in the first member of the connecting assembly is sized and configured to, when the second member of the connecting assembly is in the first position in which the towing arm is extended and the foot is retracted, be aligned with the third opening formed in the second member of the connecting assembly to receive a fastener that secures the connecting assembly in the first position.

19. The trailer as in claim 13, further comprising:
a retaining member;
an opening formed in the retaining member;
an opening formed in the handle assembly;
a first opening formed in the second member of the connecting assembly;
a second opening formed in the second member of the connecting assembly;
wherein the connecting assembly includes a first member and a second member movably connected to the first member, the second member including a towing arm and a foot, the second member being sized and configured to move between a first position in which the towing arm is extended and the foot is retracted and a second position in which the towing arm is retracted and the foot is extended;
wherein the handle assembly is movably connected to the connecting assembly, the handle assembly being sized and configured to move between an extended position and a retracted position relative to the connecting assembly;
wherein the opening formed in the handle assembly is sized and configured to, when the handle assembly is in the retracted position and the second member of the connecting assembly is in the first position in which the towing arm is extended and the foot is retracted, be aligned with the first opening formed in the second member to receive a fastener that secures the handle assembly in the retracted position;
wherein the opening formed in the handle assembly is sized and configured to, when the handle assembly is in the extended position and the second member of the connecting assembly is in the second position in which the towing arm is retracted and the foot is extended, be aligned with the second opening formed in the second member to receive a fastener that secures the handle assembly in the extended position; and
wherein the opening formed in the retaining member is sized and configured to, when the handle assembly is in the extended position and the second member of the connecting assembly is in the second position in which the towing arm is retracted and the foot is extended, be aligned with the first opening formed in the second member to receive a fastener that secures the connecting assembly in the second position.
